(19) United States
(12) Patent Application Publication
(10) Pub. No.: US 2018/0107951 A1
(43) Pub. Date: Apr. 19, 2018

(54) CUSTOMIZED LOCATION-SPECIFIC TRIP GENERATION

(71) Applicant: Microsoft Technology Licensing, LLC, Redmond, WA (US)

(72) Inventor: David Mowatt, Dublin (IE)

(21) Appl. No.: 15/293,476

(22) Filed: Oct. 14, 2016

(51) Int. Cl. G06Q 10/02; G06F 17/30

(52) U.S. Cl. CPC G06Q 10/025; G06F 3/0484; G06F 17/30241

(57) ABSTRACT

A customized location-specific trip generation service manages a trips data resource and provides customized location-specific trips. The trips data resource can include a plurality of trips, each trip having two or more individually specified destinations and associated metadata. The service can obtain geographical information and user information from user input of a request for customized location-specific trip generation; and identify a set of relevant trips from at least the trips data resource, based on the geographical information and the user information. The set of relevant trips may be provided to a source of the request.

### BACKGROUND

Planning a vacation may be accomplished in a variety of ways, such as through a travel agent, searching travel websites, such as TRIPADVISOR, a registered trademark of Trip Advisor, LLC, or using printed guidebooks.

However, performing a web search for a vacation destination can be very challenging for the user. Often times it is difficult to compare the whole experience of going somewhere, as well as visiting places around it. Instead, the user must look up a destination, then look up attractions near the destination, then work out which attractions they might visit. This method is a piecemeal approach to search for what to do in one location, and is almost impossible to easily compare to a second location.

### BRIEF SUMMARY

Applications and services providing customized location-specific trip generation are described. Through the described applications and services, users will be able to search travel information faster and more efficiently.

A customized location-specific trip generation service (“trip generation service”) manages a trips data resource; and can receive, via a submission portal, at least one trip to store in the trips data resource. The trips data resource, can include a plurality of trips, each trip having two or more individually specified destinations and associated trip metadata and specified destinations metadata. The trip metadata can include a trip identifier and a description or keyword tags. The specified destinations metadata can include a destination identifier for each of the two or more individually specified destinations and geographical location for each of the two or more individually specified destinations. Keywords, descriptions, and cost may also be included as part of the specified destinations metadata.

The trip generation service can obtain geographical information and user information from user input and can then identify a set of relevant trips from at least the trips data resource, based on the geographical information and the user information. Obtaining the geographical information can include determining a geographical interest from the user input. Obtaining user information can include receiving a user identification from the user input and obtaining second user information based on the user identification from a user data resource, the second user information comprising stored user preferences and user history. Once the service has identified a set of relevant trips, the set of relevant trips may be provided to a source of the request for customized trip generation.

Additionally, the trip generation service may dynamically generate a second set of relevant trips from a destinations data resource, based on the geographical information and the user information. The destinations data resource includes a plurality of destinations having singular geographical reference points and associated metadata. Both the dynamically generated set and the set from the trips data resource can be provided to the source of the request.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A-1D illustrate an example operating environment in which various embodiments of the invention may be practiced.

FIGS. 2A-2E illustrate example processes for providing customized location-specific trip generation.

FIGS. 3A-3C illustrate example scenarios of a customized trip generation carried out at a mobile application or web application.

FIG. 4 illustrates components of a computing device that may be used in certain implementations described herein.

FIG. 5 illustrates components of a computing system that may be used to implement certain methods and services described herein.

### DETAILED DESCRIPTION

Applications and services providing customized location-specific trip generation are described.

A customized location-specific trip generation service (“trip generation service”) is provided that manages a trips data resource for improved searching of destinations for a cohesive itinerary. The service can facilitate the collection of trips containing more than one specific location related at least by geographical cluster. For example, the trip generation service can receive, via a submission portal, at least one trip from a trip submitter. As an illustration of a submitter, institutions, such as a travel agency, wishing to propose certain areas or routes do not have to promote each specific location individually. Rather, a full ‘package’ or ‘area’ or ‘route’ can be presented.

Often, applications and services provide mechanisms to submit and present single points of interest in a particular geographical destination to a user, be it a hotel, a landmark, or a restaurant. Although multiple activity locations, hotel locations, or landmark locations may be available to search and display on a single screen, these results do not present in a cohesive unit such that an individual user can compare advantages and disadvantages of a full package (e.g., a potential itinerary). For example, Bruges, Belgium is a really pretty place to walk around with many restaurants and little shops; however, a search of activities in Bruges might indicate that a highly rated restaurant is five miles away and the popular shops are in Brussels. The described trip generation service enables a geographic cluster of destinations (or a string of geographic clusters of destinations) to be grouped as a trip and searched as cohesive units.

Unlike printed guidebooks, the described trip generation service enables the generation of trips customized for a user where dynamically generated trips and trips created by a community (e.g., other users of the service and individuals and businesses who wish to include their destinations of interest) can be added.

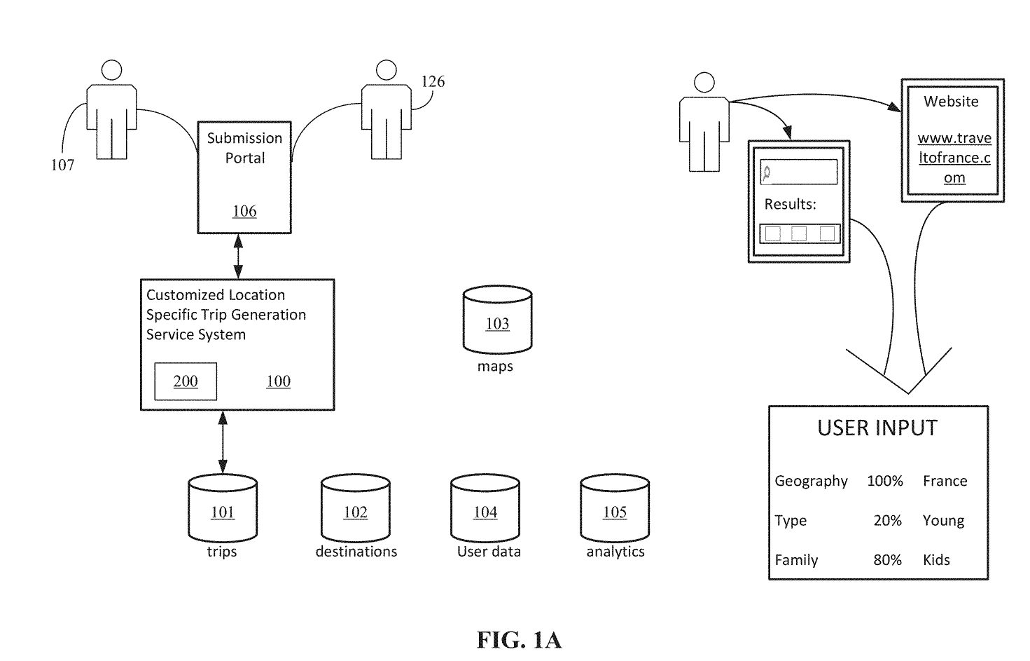

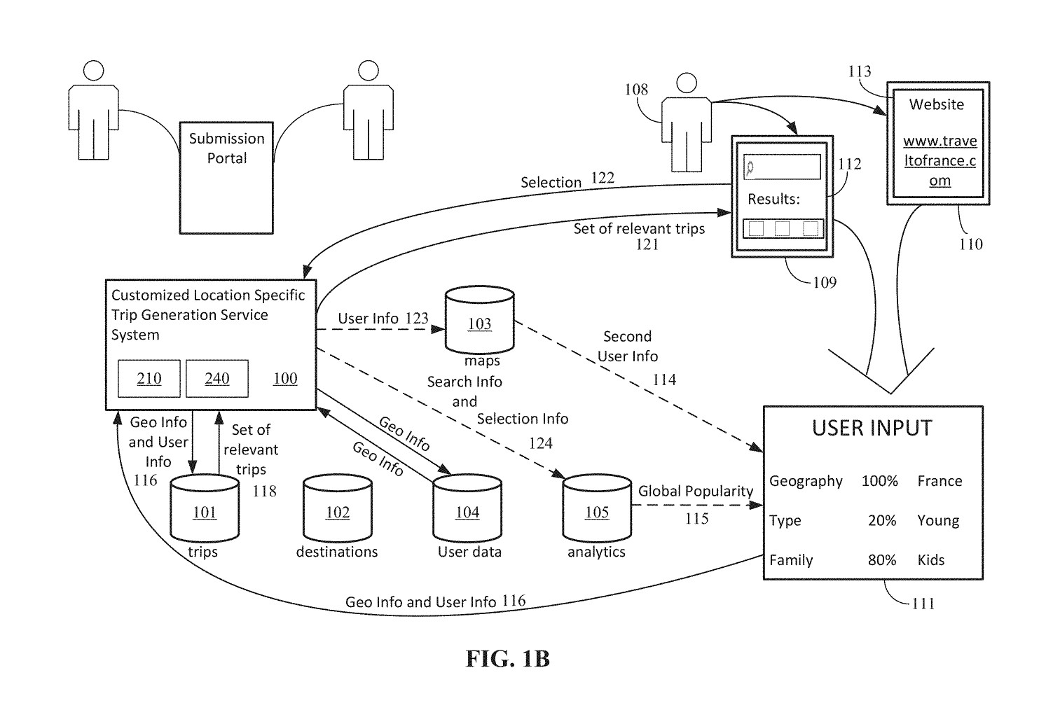

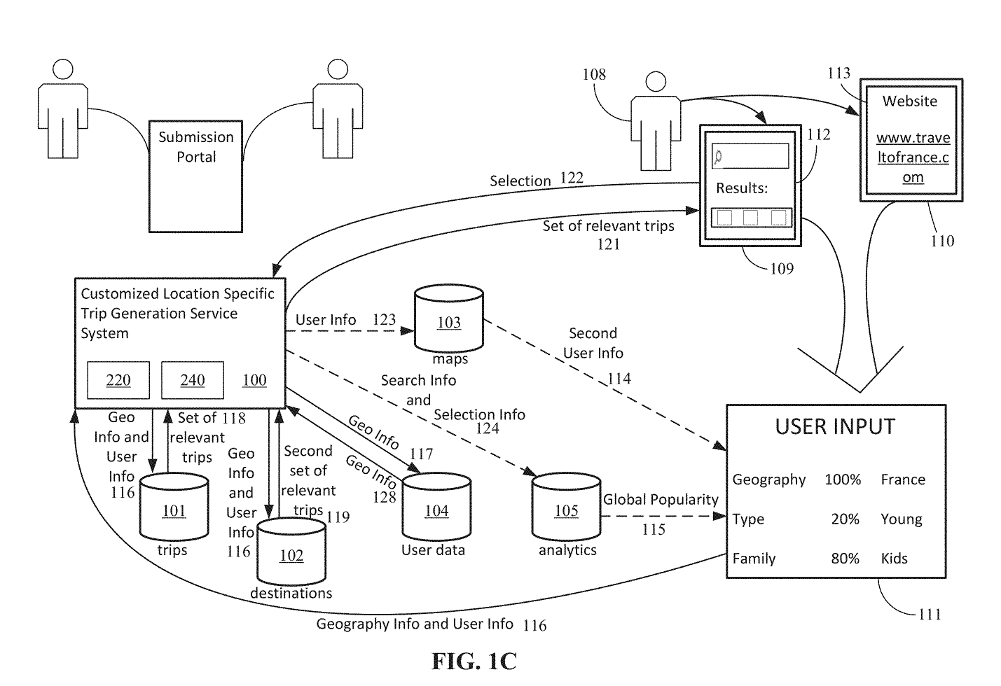

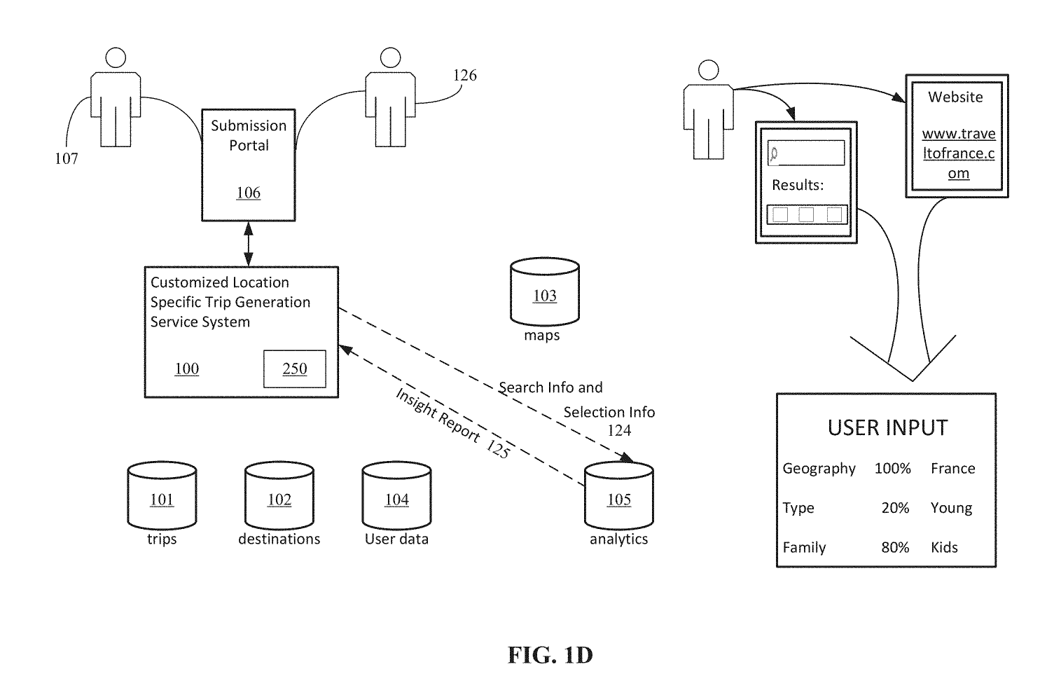

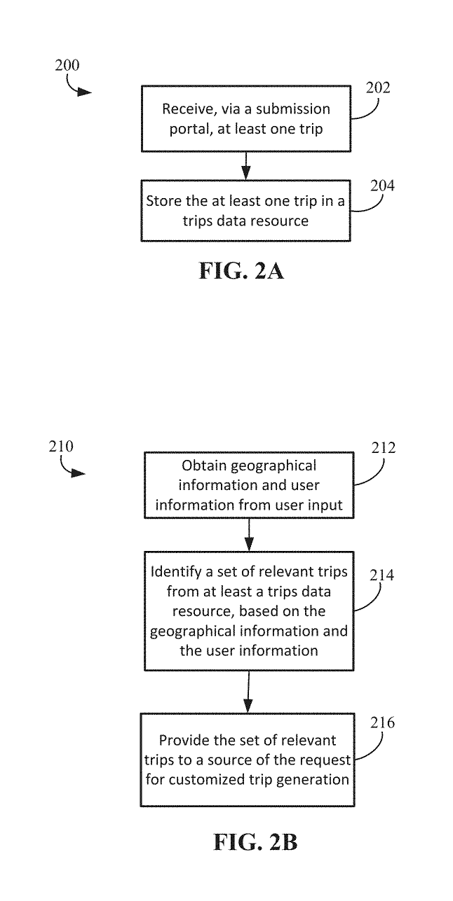

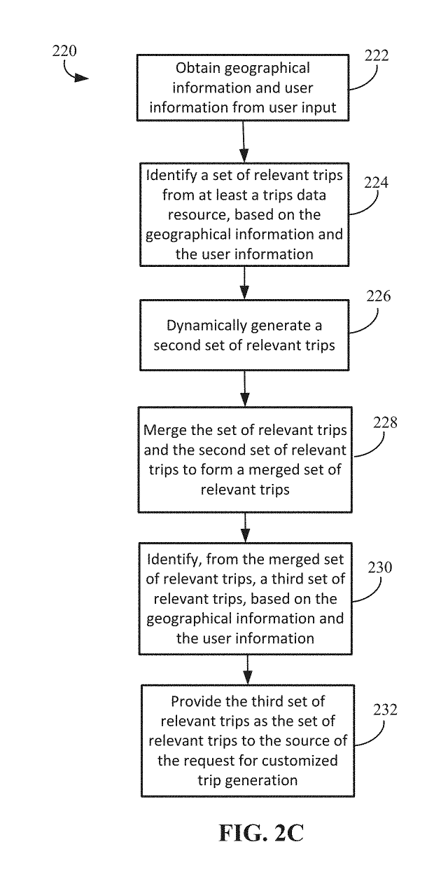

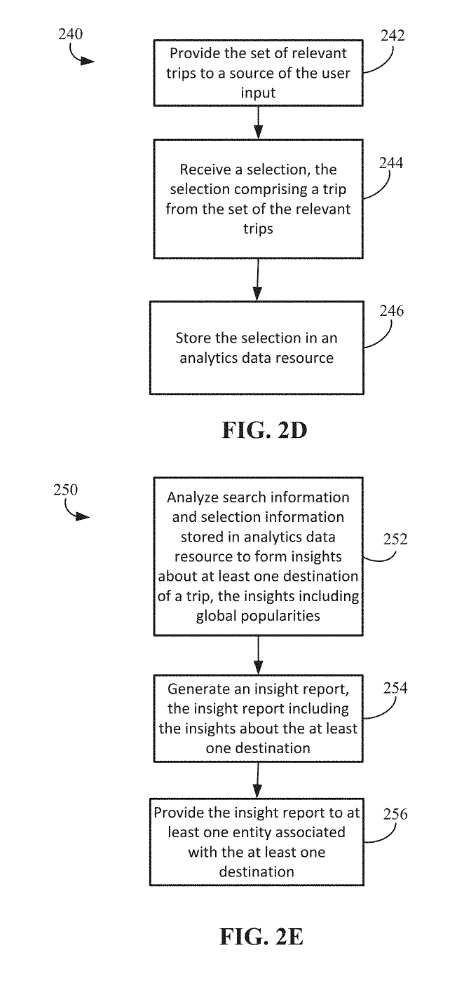

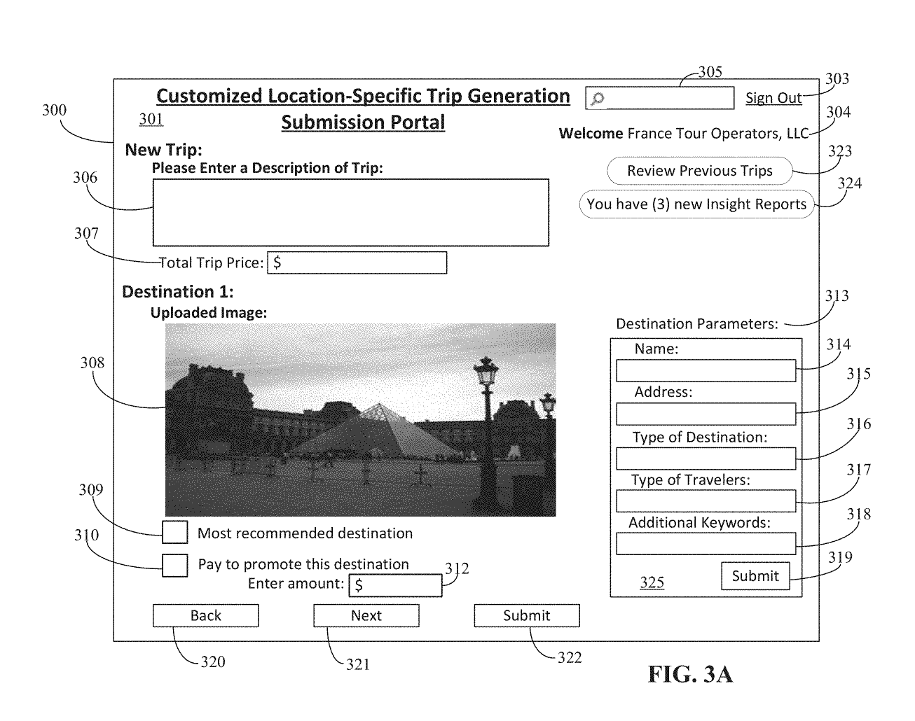

FIGS. 1A-1D illustrate an example operating environment in which various embodiments of the invention may be practiced; and FIGS. 2A-2E illustrate example processes for providing customized location-specific trip generation.

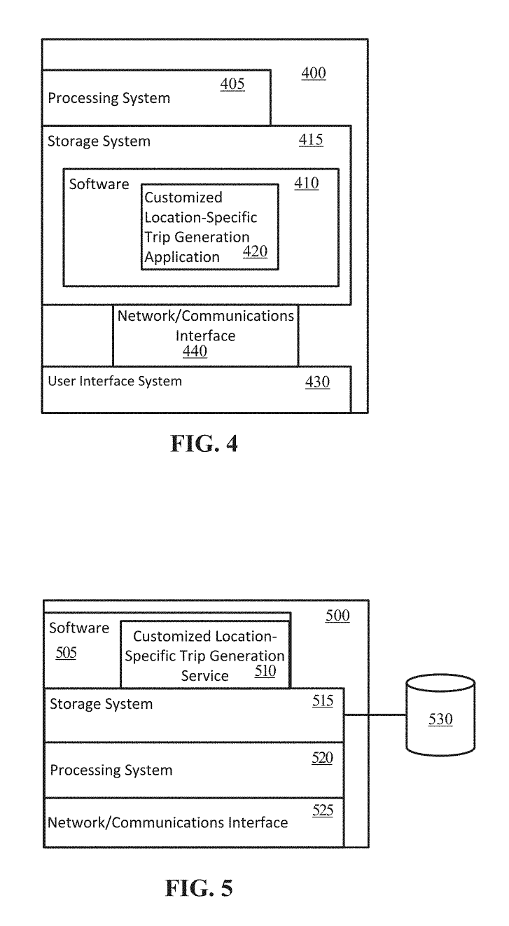

Referring to FIGS. 1A-1D, a trip generation service performing one or more of processes 200, 210, 220, 240, and 250 described with respect to FIGS. 2A-2E, can be implemented by a system 100, which can be embodied as described with respect to computing system 500 as shown in FIG. 5 and even, in whole or in part, by computing system 400 as described with respect to FIG. 4. System 100 may include or communicate with one or more resources such as a trips data resource 101, a destinations data resource 102, a mapping data resource 103, a user data resource 104, and an analytics data resource 105, each of which may store data sets.

The trips data resource 101 may contain a plurality of trips, each trip having two or more individually specified destinations and associated trip metadata and specified destinations metadata. The trip metadata can include a trip identifier. The specified destinations metadata can include a destination identifier for each of the two or more individually specified destinations and geographical location for each of the two or more individually specified destinations. Keywords, descriptions, images, and cost may also be included as part of the trip and specified destination metadata. For example, each trip may be annotated with a notion of who the trip is likely to appeal to (e.g., young singles, couples, family, people on business, elderly, or disabled-friendly). Each trip may also have a price or price bracket (e.g., $-$$$$$) associated with the trip. Further, additional interest or keywords may be associated with each of the two or more destinations of the trip or the trip as a whole, such as sun, beach, walking, technology, architecture, history, kids, or the like. The metadata may be manually annotated or automatically derived by the system.

Trips may be submitted for storage in the trips data resource 101, via a submission portal, where a user may submit their trip. A more detailed discussion of a trip submission will be discussed later.

The destinations data resource 102 may contain a plurality of destinations having singular geographical reference points and associated metadata, such as a location name, geographical location and information such as keywords and price. For example, the destinations data resource 102 may contain a list of destinations. A destination may include, but is not limited to, a hotel, a restaurant, a shop, and a public place. In some cases, the system 100 may call external data resources to enhance the list of destinations. For example, TRIPADVISOR or BING may provide user ratings for the list of destinations. In some cases, the system 100 may perform fuzzy matching on the names and geographical locations of the destinations to allow duplicate destinations across external data resources to be merged into a master list of destinations in the destinations data resource. Therefore, the individual destinations in the list of destinations may largely be predefined. For example, there may initially be a list of destinations in the destinations data resource 102. Then, the list of destinations may be enhanced with information or added to (with additional destinations) by using external data resources (like TRIPADVISOR, HOTELS.COM, YELP, etc.).

The mapping data resource 103 may contain a vector representation of a geographical region, such as a town or a neighborhood, allowing each geographical location in the destinations data resource 102 to be identified as being within a labeled geographical region (e.g., a town, a district, or the like). In some cases, the system 100 may call a separate mapping service, such as MICROSOFT BING or GOOGLE MAPS. Additionally, in some cases, each geographical region may contain a rating based on, for example, beauty, architecture, and history. The rating may be generated from reviews available from sites hosting or collecting reviews such as YELP, TRIPADVISOR, and even search engine services such as available through GOOGLE, BING, and YAHOO.

The mapping data resource 103 may allow the system 100 to identify how far apart one destination is from another destination. The system 100 may use the geographical information included in the metadata associated with each of the destinations stored in the destinations data resource 102 to derive the distance between destinations. This may allow the system 100 to ensure destinations for a location-specific trip are suggested that are within close proximity. For example, if the user input includes geographical information indicating a desire for a 3-day trip on the East Coast of the United States of America, the user would not want the system to suggest a trip that involves the combination of New York City, Boston, and the North Pole.

The user data resource 104 may contain a plurality of user identifications and associated metadata, including stored user preferences and user history. The user data resource 104 may receive user information from the system 100, or through a myriad of sources, such as a social media site or an internet monitoring service associated with a web browser or search engine. The user information stored in the user data resource 104 may be used to enhance the user input. In one example, the user data resource 104 may provide user information that varies depending on the user's location. For instance, the user data resource 104 may provide user information on how much users from that country travel to a given destination (e.g., what is the typical price of flights for a specific destination). In another example, the user data resource 104 may provide user information about the user's activities and likes, for example, information about the user gathered from FACEBOOK data or from cookies the internet monitoring service has tracked. The stored user preferences and user history may be referred to as usage data. The gathering and storing of usage data will be discussed in more detail later on.

The analytics data resource 105 may contain search information and selection information from a plurality of users. The search information and selection information may be analyzed to form insights, including global popularities within the trip generation website and application. The global popularities may show, for example, what the current most popular preferences are for certain trips or destinations or which trips or destinations are currently being selected the most by certain age groups. In one example, the search information and selection information may be analyzed to show that a specific trip stored in the trips data resource 101 is associated with people who self-identify as having kids. Further insights may be derived for groups of users, for example, which trips are preferred by travelers with families. The global popularities that may be formed can be used to enhance the user input. Further, as will be discussed in more detail, an insight report may be generated from the analyzed information, which may be sent to at least one entity associated with a destination.

Components (computing systems, data resources, and the like) in the operating environment may operate on or in communication with each other over a network (not shown). The network can be, but is not limited to, a cellular network (e.g., wireless phone), a point-to-point dial up connection, a satellite network, the Internet, a local area network (LAN), a wide area network (WAN), a WiFi network, an ad hoc network or a combination thereof. Such networks are widely used to connect various types of network elements, such as hubs, bridges, routers, switches, servers, and gateways. The network may include one or more connected networks (e.g., a multi-network environment) including public networks, such as the Internet, and/or private networks such as a secure enterprise private network. Access to the network may be provided via one or more wired or wireless access networks as will be understood by those skilled in the art.

As will also be appreciated by those skilled in the art, communication networks can take several different forms and can use several different communication protocols. Certain implementations of the described trip generation service can be practiced in distributed-computing environments where tasks are performed by remote-processing devices that are linked through a communications network. In a distributed-computing environment, program modules can be located in both local and remote computer-readable storage media.

Communication to and from system 100 may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

Referring to both FIG. 1A and FIG. 2A, a trip generation service, such as implemented by system 100, manages the trips data resource 101 and can receive, via a submission portal 106, at least one trip (202). In some cases, the submission portal 106, or another interface, may be accessible through a web browser executing on a user device. In another example, the user 107 may search a travel website or application and select at least two destinations, the selections then being communicated by the travel website or travel application to the trips generation service. As another example, a user 107 may fill in trip parameters on a form available from an application or website (which may be a trips generation application or include a trips generation feature). Accordingly, the user 107, acting as an entity associated with the destination, may take a set of two or more destinations that are atomic and unrelated to begin with, define interesting sets of the destinations, and submit the set to the submission portal 106.

In some examples, the submission portal 106 may also allow the user 107 to provide associated metadata with the set of two or more destinations (e.g. the trip). The user 107 may provide information about the trip including a description, keywords and price. The user 107 may also, for each destination included in the trip, provide a name, geographical location, and information about the destination including a photograph, a description, and keywords. For example, each trip may be annotated by the user 107 with a notion of who it appeals to (e.g., young singles, family, people on business, or elderly couples). Each trip may also have a price or price bracket (e.g., $-$$$$$) associated with the trip. Further, additional interest (e.g., keywords) may be associated with each of the two or more destinations or each trip, such as sun, beach, walking, technology, architecture, history, kids, or the like. For example, the first destination included in a relevant trip may be a hotel on the beach and the second destination included in a relevant trip may be a hiking trail to Mayan ruins. The user 107 may tag the first destination with the keywords sun and beach and might tag the second destination with the keywords walking and history.

The user 107 may be, but is not limited to, a vested party, a partner, a group, or a community member. Examples of a vested party may include a tourist agency selling a vacation that involves visiting several destinations, a cycle club encouraging a cyclist to ride their way through various destinations, a professional entity, such as the tourist board, calling attention to a collection of places a tourist should visit during a vacation. Further, the trip may be submitted by any member of the community, such as a traveler who visited a set of closely located destinations and who would recommend a similar trip to others.

Once the system 100 has received the at least one trip via the submission portal 106 (202), the at least one trip is stored in the trips data resource 101 (204). In some cases, an owner 126 of a destination may utilize the submission portal 106 to submit a single destination (e.g. their business). For example, an owner of a restaurant in New York City would like to promote their restaurant on the trips generation application. The owner can submit their restaurant as a destination via the submission portal on the trips generation application. In this case, the single destination may be stored in the destination data resource 103 for later inclusion in, for example, a dynamically generated trip.

In some examples, the trips data resource 101 may also store dynamically generated trips that were generated using at least some of destinations stored in the destinations data resource 102, as will later be discussed in more detail.

Referring to FIG. 1B and FIGS. 2B and 2D, a trip generation service, such as implemented by system 100, and performing processes 210 and 240, may obtain a set of inputs that may include time, geographical location, price, user preferences, and the like, and not only return a destination, but a selection of destinations that are attractive to the user.

Referring to FIGS. 1B and 2B, the system 100 may obtain geographical information and user information from user input 111 (212). An end user 108 may interact with a user computing device 109 running an application, such as trip generation application 112, through a user interface (UI) (not shown) to enter user input 111. A computing device (e.g., the user computing device 109) is configured to receive input (e.g. the user input 111) from a user (e.g. end user 108) through, for example, a keyboard, mouse, trackpad, touch pad, touch screen, microphone, camera, eye gaze tracker, or other input device. The UI enables a user to interact with various applications, such as a trip generation application 112, running on or displayed through the user computing device 109. Generally, the UI is configured such that a user may easily interact with functionality of an application. For example, a user may simply select (via, for example touch, clicking, gesture, or voice) an option within the UI to perform an operation such as scrolling through a set of relevant trips of the trip generation application 112.

The user computing device 109 can be, but is not limited to, a personal computer (e.g. desktop computer), laptop, personal digital assistant (PDA), video game device, mobile phone (or smart phone), tablet, slate, terminal, and the like. It should be apparent that the user computing device 109 maybe any type of computer system that provides its user the ability to load and execute software programs and the ability to access a network, and may be embodied as described with respect to system 400.

The trip generation application 112 can be stored on the user computing device 109 (e.g., a client-side application) or accessed as a web-based trip generation application 113 (e.g., running on a server or hosted on a cloud) using a web browser 110 (e.g., a standard internet browser), and the application's interface may be displayed to the end user 108 within the web browser 110. Thus, the application may be a client-side application and/or a non-client side (e.g., a web-based) application. The trip generation application 112 can communicate with the system 100 (and which may provide the trip generation service).

The user input 111 may be received through a variety of channels and in a number of ways. In one example, the end user 108 may be presented with an input field where natural language input (verbal or keyed) can be provided through which the user input 111 can be input. In another example, the end user 108 may be presented with a feature to select filter options before beginning the search process or later to additionally refine the results. In yet another example, the end user 108 may select a link to an advertisement for a vacation on a website in the web browser 110.

In an example of the natural language input, the end user 108 may ask general questions, such as “where should I get married” or “where should I go on vacation”. In another example of the natural language input, the end user 108 may ask very specific questions, such as “where do I go on vacation on Spring Break near Florida with my 2 young sons” or “I'm driving from Paris to Marseilles, what should I see on the way”. In some examples, the end user 108 may be asked an optional set of clarifying questions, such as what type of vacation is desired.

The geographical information and user information obtained from the user input 111 may include, but is not limited to, a current date, stated user preferences, parameters sent by the webpage or application issuing the user input 111, user history, and stored user preferences.

The current date may be included in the user information to permit the system 100 to identify the current season, as certain locations' attractiveness may improve or worsen in the winter months versus the summer months.

The stated user preferences may be the stated user preferences of the end user 108 and may be included in the user information and obtained through user input 111 entered into the input field or selected through the filter options. Examples of the stated user preferences may include a desired time of travel, a vacation preference, such as a relaxing vacation or an adventurous vacation, a type of entity to retrieve, such as a town, a neighborhood, or a region, desired amenities in the area, and area preference, such as historic, scenic, beach, nightlife or the like. Further examples include statements of “for a sunny holiday” and “an eco-wedding” or for high quality to be a more important factor than budget cost.

In some examples, the geographical information may include parameters sent by the webpage or application issuing the user input 111. The parameters may include whether a neighbourhood, a town, or a region is sought and what the maximum travel time between the top destinations (e.g. 30 minutes vs. 1 day) may be.

The geographical information and user information obtained from the user input 111 can be input that articulates the intent of the end user 108. In some cases, obtaining the user information may include obtaining the user information received directly from the end user 108, such as the stated user preferences of the end user 108. In other cases, obtaining the user information may further comprise receiving a user identification from the user input and obtaining second user information 114 based on the user identification from the user data resource 103. The second user information 114 may include the user history and the stored user preferences. The user history may be the user history of the end user 108 and may include, for example, information that includes attractions that were visited and liked (e.g., from a data resource such as a social media site or that were saved from previous trips viewed or selected by the user of the trip generation service). The stored user preferences may be the stored user preferences of the end user 108 and may include, for example, in previous selections and/or stated preferences that high quality was a more important factor than budget cost and that a hotel room with a balcony and a view of the beach is preferred over a hotel room with no balcony and a view of the courtyard.

In some cases, obtaining the geographical information may include the geographical information received directly from the end user 108, such the end user 108 pre-selecting certain geographical areas that appeal to them. However, in other examples, the geographical information may not be clear from or included in the user input 111. In some of these cases, a geographical interest may be determined from the user input 111. For example, a college student may ask a general question in the input field of the trips generation application 112, such as “where should I go on spring break”. A geographical interest for the student may be determined from the user input by receiving stored user preferences and user history related to geographical information from the user data resource 103. The student may have previously selected vacations only in sunny, beach locations in the Caribbean. Further, the student may have previously used the user settings options to provide state preferences of nightlight and budget over high quality. The system may then determine the geographical interest to be an area in the Southern United States into the Caribbean, such as Cancun, Mexico or Daytona Beach, Florida. The determined geographical interest may then be used as the geographical information of the user input.

Additionally, further input, which may be global popularities 115 within the website and application, may be obtained and included in the geographical information and user information. The global popularities 115 may include which destinations are paid to be promoted and which destinations are popular with users right now. The global popularities 115 can include clustered popularities. Examples of clustered popularities include, but are not limited to, destinations clustered based on what families like, destinations clustered based on what students like, and destinations clustered based on the region a person is from (e.g., Germany, the South East United States, etc.).

In some examples, the system 100 may then, through obtaining the combination of the geographical information and user information of the user input 111, determine that the information indicates a certain preference(s) of the user 108 for a certain type of vacation. For example, the geographical information and user information may provide a preference having to do with a geography, a preference for a particular type of vacation, or a preference that may have to do with family. Further, these preferences may have a certain weight associated with just how strongly the preference is. For example, the geography preference may provide a preference for France with a weight of 100%; the preference for the type of vacation may provide a preference for a young couple (as opposed to an older couple) with a weight of 20%; and the preference having to do with family may provide a preference for kids (as opposed to no kids) with a weight of 80%. In some cases, these preferences may be used to help when identifying relevant trips.

Once all the geographical information and the user information is obtained (212), the system 100 may then identify a set of relevant trips from at least the trips data resource 101, based on of the geographical information and the user information (214). In one example, the trip generation service may receive the geographical information and the user information 116 from the application. The geographical information and the user information 116 may then be compared against the plurality of trips in the trips data resource 101 to identify a set of relevant trips.

In one example, the trip generation service may search and/or traverse at least the trips data resource 101 and compare the geographical information and the user information 116 against the metadata associated with the at least two destinations of each trip, to identify the set of relevant trips satisfying certain criteria. The certain criteria generally entail a resulting match (which may be a fuzzy match) with at least one of the geographical information and the user information. For example, the service may, based on the geographical information and the user information 116, look for a similarity in the destination and a similarity in whether the destination is family friendly. Once the subset of trips that have a match (e.g., a fuzzy match) are identified, these trips can be sorted (e.g., ranked from most relevant to least relevant) and a certain top number of trips can be provided. The process of identifying the set of relevant trips satisfying certain criteria can, thus, entail a RECALL of matching trips and a sort by RANKING to produce an ordered list that can be used to identify an appropriate number of relevant trips for the set.

Once the set of relevant trips 118 have been identified (214), the system 100 may provide the set of relevant trips 121 to the source of the request (216). The source of the request may be the trip generation application 112 stored on the user computing device 109 or the web-based trip generation application 113 accessed using the web browser 110.

In some examples, when the trip generation service identifies the set of relevant trips 118, the service may perform additional optimizations on the set of relevant trips before providing the set to the source of the request. For example, the service may find that three trips are a match to the geographical information and the user information 116 and each of these trips may have up to ten individual destinations that the end user 108 can choose from. Often times, especially for an end user on a mobile phone, there may not be enough room on their display to show all ten destinations, and scrolling through all ten destinations may become too time consuming, especially when multiple relevant trips are provided.

Advantageously, the service may not only provide the most relevant trips, but provide the most relevant destinations within each of the most relevant trips for a user. For example, the service may know, through obtaining the geographical information and the user information 116, that the end user 108 is traveling with kids. Once the system 100 has identified a set of relevant trips, for example three trips, the system 100 can then do a secondary search and/or traverse of set to identify the top three the most kid friendly destinations for each trip. Therefore, when the set of relevant trips are provided to the end user 108, an image and description of the top three most kid friendly destinations are displayed, instead of the default first image and description. This allows the end user 108 to see more appealing destinations of a trip without the need to view every destination within the trip provided.

Additionally, the service may underpin a hotel's website, which may allow any Internet user to see a customized version of what will appear to that user. For example, a family with kids may see a particular room advertised with free movies and snacks for kids, as well as local fun fares, while an elderly couple may see a quiet room with a view and the nearby museums.

Referring now to FIGS. 1B and 2D, once the set of relevant trips have been provided to a source of the request (242), the end user 108 may receive the set of relevant trips (243). Then, the end user 108 may indicate a selection 122 comprising a trip from the set of relevant trips (244) and the selection 122 may be received by the system 100 (245). The selection may then be stored in the analytics data resource 105 (246). Additionally, the system 100 may gather the selection information and search information received from the end user 108 and store the selection information and search information 124 in the analytics data resource 105 to be included and analyzed as global popularities. Further, the system 100 may gather the user information received from the end user 108 and store the user information 123 in the user data resource 103 to be included in the second user information 114.

In more detail, while the user is inputting user information and carrying out a search of relevant trips in a UI, the user preferences can be stored for each session. For example, when a user inputs user information in the trip generation application, the user preferences can be stored. The storing of the user preferences can be performed locally at the user computing device 109 and/or by a server (such as system 100). User preferences and other usage information may be stored specific for the end user 108 and collected over a time frame. The collected data may be referred to as usage data. The trip generation application 112 and/or website 113 may collect the information about user preferences as well as other activity user performs with respect to the trip generation application 112 and/or webpage 113. Usage data can be collected (with permission) directly by the trip generation service or first by the trip generation application 112 or website 113. It should be understood that usage data does not require personal information and any information considered to be personal or private would be expected to be expressly permitted by the user before such information was stored or used.

In some embodiments, usage data is increased by collecting data from the same end user across devices. The across-device collection can be carried out, for example, where a user signs in to use a program or accesses the program from a client device communicating with a server (such as system 100) running the trip generation application. In some embodiments where a user uses a same product or program on multiple devices, user preferences within one session on one computing device may be combined with user preferences within a session on another computing device in order to capture additional usage data from the user.

Usage data can be stored, for example as popularity records, at user data resource 103, a third party data resource, or even at analytics data resource 105. The usage data can be an aggregate of usage data for a community of users. For example, user preferences and other usage information from users of other computing devices, such as second user computing device (not shown) and third user computing device (not shown), can be communicated over the network (not shown) and stored as part of the usage data, which can allow for multiple-user analytics.

Referring to FIG. 1C and FIGS. 2C and 2D, a trip generation service, such as implemented by system 100, may perform the processes 220 and 240. Referring now to FIGS. 1C and 2C, as previously described, the system 100 may obtain geographical information and user information from user input 111 (222). The system 100 may then identify a set of relevant trips from at least the trips data resource 101, based on of the geographical information and the user information (224), as described previously.

Further, the system 100 may dynamically generate a second set of relevant trips (226) from the destinations data resource 102, based on the geographical information and the user information. Dynamically generating the second set of relevant trips may include comparing the geographical information and user information against all individual destinations in the destinations data resource 103 or other accessible destination data resources. In one example, the trip generation service may receive the geographical information and the user information 116 from the application, and the geographical information and the user information 116 may then be compared against the plurality of destinations in the destinations data resource 102.

In some cases, in order to dynamically generate a set of relevant trips, the plurality of destinations may be clustered into area clusters based on the geographical location of each of the plurality of destinations. Each area cluster may include at least two destinations and therefore, can represent an individual relevant trip. Each area cluster may also represent, for example, a town, a neighbourhood, or a region. Further, each area cluster may also represent an individual trip. Each of the area clusters may then be assigned a score based on the geographical information and user information from the user input 111. In one example, the score of each area cluster may be assigned by calculating a score based on the following formula: a median ranking score of the destinations that the area cluster contains+a normalized count of a total number of destinations to visit nearby the area+user ratings about the area+a score for a similarity of a match between the area and the user preferences provided in the user information.

Each of the area clusters may then sorted based on their assigned score to form the second set of relevant trips. The second set of relevant trips may include a list of area clusters with a ranked list of things to do in that area. For example, countries to vacation in, or be it locations to get married.

As previously described, the mapping data resource 103 may allow the system 100 to identify how far apart one destination is located from another destination. The system 100 may use the geographical information in the metadata associated with the destinations 117 stored in the destinations data resource 102 to derive geographical information 128 about each destination in the second set of relevant trips 119, such as the distance between destinations. This may allow the system 100 to ensure destinations for a location-specific trip are suggested that are within close proximity.

In some examples, the geographical information and user information may also ensure that a list of things to do in the area cluster includes a place of a certain type, e.g. a wedding venue if you're showing spots to get married, or a hotel if it's a vacation.

In some examples, pre-processing and caching may be utilized so that not every search and/or traverse of the destinations data resource 102 requires every entity in the system to be processed. In some cases, the specific implementation may depend on the scenarios that will be optimized. For example, if a user wishes to retrieve a list of popular places to visit, the service may pre-compute the rank based on the general popularity of an area and the quantity of things to do in it. This may allow the service to work with a short list of destinations, for example, a top fifty list, so that when the user wants something more specific (e.g. a great beach holiday), only the short list of area clusters is considered.

Once the short list is further filtered and re-ranked by adding on geographic information and user information specific scores for the quality of beaches in each area cluster, a second search and/or traverse of the destinations data resource 103 is executed to retrieve the best trips as submitted in the portal. In this case, a fuzzy matching may be applied that takes the preferences of the end user around, for example, location, price, type of trip, and number of travelers, and a 1-n list of trips can be derived.

In some examples, a feedback loop can be implemented. The feedback loop may support the system 100 and providing the most relevant trips. For example, if a particular ‘top three places to visit’ in the area of Paris does not resonate with most website visitors, an alternate set of trips or destinations may be shown. This may be achieved by remembering a click-through rate on the destinations to visit (shown under the heading ‘Paris’) and introducing a penalty system if the scores are low. The click-through rate refers to the ratio of the number of users who click on a link versus the total number of users who view the page containing the link.

Once the set of relevant trips 118 has been identified (224) and the second set of trips 119 has been dynamically generated (226), the system 100 may merge the sets of relevant trips 118 and the second set of trips 119 to form a merged set of relevant trips (228). In some examples, the service may merge these sets such that recommendations of purchasable trips are promoted slightly more, allowing the service to make a higher profit.

The system 100 may then identify, from the merged set of relevant trips, a third set of relevant trips, based on the geographical information and the user information (230). This set could be the set of relevant trips provided to the end user 108. The third set of relevant trips are then provided to a source of the user input as the set of relevant trips (232).

In some cases, when identifying the third set of relevant trips, only the very top (e.g., the top ten) area clusters from the merged set of relevant trips are searched and/or traversed and the top destinations within those are retrieved, again allowing for user-preferences to be applied to the destinations each relevant trip contains. For example, if the end user 108 has children and a relevant trip has six relevant destinations, the child-friendlier places may be chosen to showcase for that location. This allows for the top destinations within each relevant trip to be a personalized set.

Referring now to FIGS. 1C and 2D, once the set of relevant trips (e.g., the third set of relevant trips) have been provided to a source of the request (242), the end user 108 may receive the set of relevant trips (243). Then, the end user 108 may indicate a selection 122 comprising a trip from the set of relevant trips (244) and the selection 122 may be received by the system 100 (245). The selection may then be stored in the analytics data resource 105 (246). Additionally, the system 100 may gather the selection information and search information received from the end user 108 and store the selection information and search information 124 in the analytics data resource 105 to be included and analyzed as global popularities. Further, the system 100 may gather the user information received from the end user 108 and store the user information 123 in the user data resource 103 to be included in the second user information 114.

Additionally, if a certain dynamically generated trip from the dynamically generated second set of relevant trips is selected and/or liked by a certain number of users or has a good click-through rate, then the system 100 may automatically store the dynamically generated trip in the trips data resource 101.

Referring to both FIG. 1D and FIG. 2E, a trip generation service, such as implemented by system 100, may perform the process 250. In some cases, if a user owns a business in a certain area, they may wish have access to an application that allows them to identify the number of users requesting their type of destination, as well as the information about those users. Advantageously, the application may allow the owner to provide the most appealing information to the users when submitting their destination to the submission portal.

The system 100 can analyze the search information and the selection information 124 stored in the analytics data resource 105 to form insights about at least one destination of a trip (252). The insights about the at least one destination may include, but are not limited to, global popularities within the trip generation website and application. In one case, the insights may be formed about one destination of the trip; and in another case, the insights may be formed about all of the destinations of the trip (e.g., the whole trip). Once the insights about the at least one destination are formed (252), an insight report 125 may be generated (254). The insight report 125 can include the insights about the at least one destination and may be provided to at least one entity associated with the at least one destination (256). The at least one entity associated with the at least one destination may be the user 107 who submitted the trip or the owner 126 of a destination included in the trip.

Through the insight report 125, the entity (e.g., the user 107 or the owner 126) associated with the at least one destination is able to receive information about their destination, such as whether their destination was included as a selected destination. In some cases, the insight report 125 may show that their whole trip was selected or that their atomic destination was selected, while being included in a dynamically generated trip. In other cases, the insight report 125 may show other destinations in the area of the entity are being selected. In further cases, the insight report 125 can notify the entity (e.g., the user 107 or the owner 126) that there is interest in their destination, as well as destination(s) close to them. Advantageously, the insight report 125 may suggest a joint venture to the entity (e.g., the user 107 or the owner 126) in order to promote people to both destinations.

For example, a user owns a music shop and is not providing a trip, but submits their shop as a destination in the trip generation application. The owner can receive an insight report stating information such as “Did you know people are interested in visiting your business?”, “They are also interested in visiting ‘The Opera House’ located 0.8 miles away.”, and “Would you like to have a joint venture with ‘The Opera House’ to visit both of you together?”. The user may then be able to contact the owner of The Opera House to further promote their business in a joint venture.

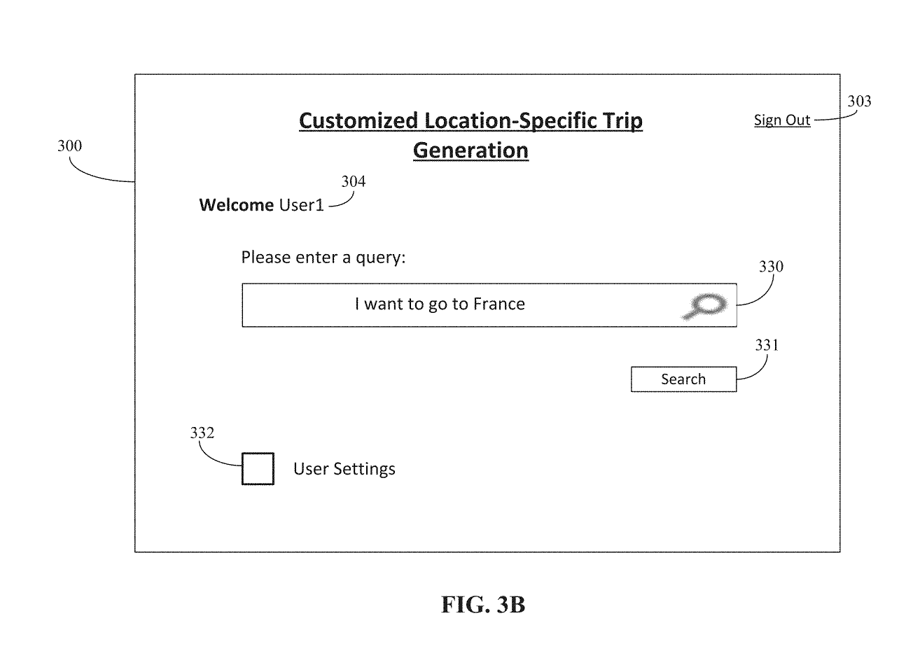

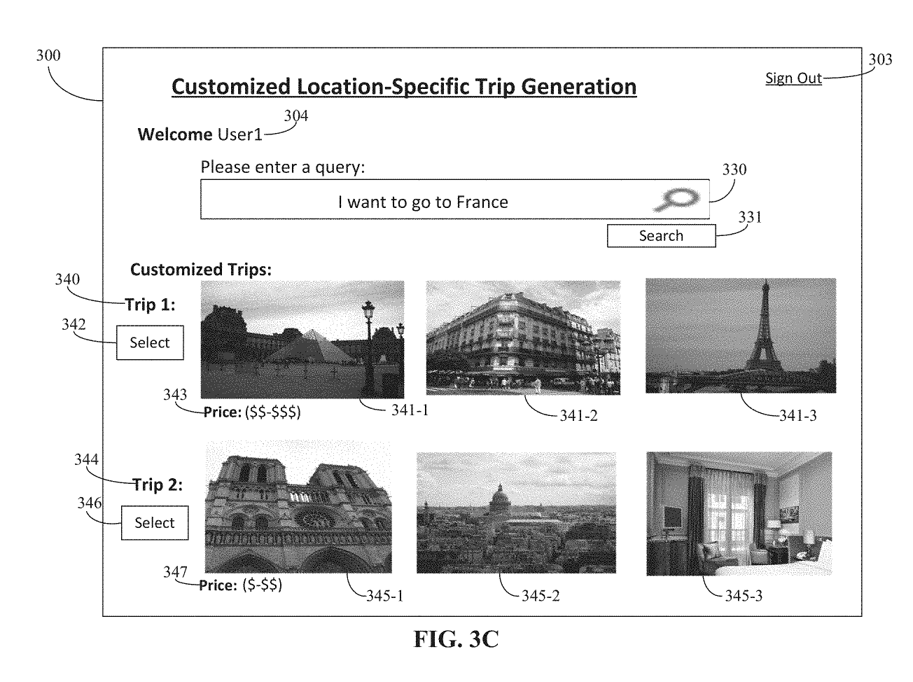

FIGS. 3A-3C illustrate example scenarios of a customized location-specific trip generation carried out at a mobile application or web application. Referring to FIG. 3A, a user may open a submission portal 301 for a trip generation application 300 on their computing device (embodied for example as system 400 described with respect to FIG. 4). The computing device can be any computing device such as, but not limited to, a laptop computer, a desktop computer, a tablet, a personal digital assistant, a smart phone, a smart television, a gaming console, wearable device, and the like.

In the submission portal 301, the user may be able to browse previously submitted trips, view received insight reports, or submit a new trip. In some cases, the user may select a sign in/sign out command 303 to sign in to the submission portal 301, to allow the system to identify the user and attach a user identification, such as a user name 304, to the user. The user name 304 may then be attached to any trips and/or destinations submitted by the user and provided with a trip included in a set of relevant trips to an end user. This may allow an end user to identify the name of the trip provider (e.g., the name of the travel agency) when reviewing relevant trips. Once indicating a new trip is to be submitted, the user may be presented with a variety of input fields, allowing the user to submit at least one destination.

According to various embodiments, the user may also be presented with a search input window 305 in the UI of the submission portal 301 for providing a search input to be used when searching travel destinations to include in a trip. For example, if a user would like to access third party travel websites while submitting a trip to the submission portal 301, they can enter input such as ‘Paris, France’.

In some cases, a user may also be able to manually input each of the destinations of a trip, including destination parameters, in the user interface (UI) of the submission portal 301. For the new trip, a description input field 306 and a trip price input field 307 may be displayed in the UI. The description input field 306 and trip price input field 307 allow the user to provide a description of the trip as a whole, as well as the total price for the trip. In some cases, the description input field 306 and the trip price input field 307 may only be provided on the display for the first destination added. In other cases, the description input field 306 and the trip price input field 307, as well as any entered text, may be provided on a display for each destination the user adds.

The user may then provide the relevant information for the first destination of the new trip. Destination parameters 313 may be input into a destination parameters fillable form 325 on the user interface (UI). The destination parameters 313 may include name 314, address 315, type of destination 316, type of travelers 317, and additional keywords 318 as some examples. Once the user has manually input all of the destination parameters 313, the user may select submit 319, within the fillable form 325.

The user may also upload an image 308 of the destination, which may be displayed to an end user when a set of relevant trips are provided. Additionally, a recommendation checkbox 309 allows the user to select the current destination as being their most recommended destination of the trip. Further, the user may select promotion checkbox 310 to pay to promote this destination. If the promotion checkbox 310 is selected, the user may enter a dollar amount into input field 312. The dollar amount entered into input field 312 is the dollar amount they would like to pay each time the service suggests this destination.

Once the user has input all of the relevant information about the first destination of the new trip into the UI, the user may select a next command 321. The next command 321 provides the user with a new display (not shown), allowing the user to add a new destination to the new trip (e.g., provide information about a second destination). The new trip may contain a plurality of destinations and when the user is satisfied with the amount of destinations in the new trip and the information provided about each destination in the new trip, the user may select the submit command 322 and the new trip is stored in the trips data resource. Additionally, the user may also select a back command 320, allowing the user to return to a previously added destination of the new trip. The next command 321 may also allow the user to move to the next previously added destination in the new trip without adding a new destination and before selecting the submit command 322. The back command 320 and the next command 321 may essentially also work as a left scroll arrow and a right scroll arrow, respectively, to move between the added destinations of the new trip.

Additionally, the user may select a review previous trips command 323, which allows the user to review any previously submitted trips. The user may then edit any of the submitted trips, such as by editing a submitted destination or adding a new destination. Further, the user may select an insight report command 324, which allows the user to view any new or existing insight reports.

Referring to FIG. 3B, a user may open a trip generation application 300 on their computing device. The computing device can be any computing device such as, but not limited to, a laptop computer, a desktop computer, a tablet, a personal digital assistant, a smart phone, a smart television, a gaming console, wearable device, and the like.

In the application 300, the user may be able to identify a good travel plan based on their preferences. In some cases, a sign in/sign out command 303 is provided to allow the user the user to register with the application and sign into the application. This may allow the system to identify the user and attach a user identification, such as a user name 304, to the user.

In some cases, an input field 330 for a natural language input can be provided through which user input about a trip can be entered. For example, the user may enter “I want to go to France” as the user input. A user settings checkbox 332 may also be provided to allow the user to further filter options and provide geographical information and user information. Once the user is satisfied with the user input provided, a search command 331 may be selected.

Referring to FIG. 3C, after the user requests to generate customized location-specific trip, for example by selecting the search command 331, a set of relevant trips may be received from the trip generation service and displayed to the user. In the illustrative example, Trip 1 340 and Trip 2 344 are shown for the set of relevant trips. Trip 1 340 may display to the user the images of the three most relevant destinations, such as image 341-1, image 341-2, and image 341-3, as well as a price bracket 343 representing the total price for the Trip 1 340. Trip 2 344 may display the images of the three most relevant destinations, such as image 345-1, image 345-2, and image 345-3, as well as a price bracket representing the total price for the Trip 2 344. For example, the price bracket 343 for Trip 1 340 may be ‘($$-$$$)’, while the price bracket 347 for Trip 2 344 may be ‘($-$$)’, meaning the total price for Trip 1 340 may be more that the total price of Trip 2 344.

Additionally, a select command (e.g., Trip 1 select command 342 and Trip 2 select command 346) may be provided to allow the user to view a trip in more detail. For example, Trip 1 select command 342 may be selected to allow the user to view each of the destinations, as well as the information provided about each destination within Trip 1 340.

FIG. 4 illustrates components of a computing device that may be used in certain implementations described herein. Referring to FIG. 4, system 400 may represent a computing device such as, but not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, or a smart television. Accordingly, more or fewer elements described with respect to system 400 may be incorporated to implement a particular computing device.

System 400 includes a processing system 405 of one or more processors to transform or manipulate data according to the instructions of software 410 stored on a storage system 415. Examples of processors of the processing system 405 include general purpose central processing units, application specific processors, and logic devices, as well as any other type of processing device, combinations, or variations thereof. The processing system 405 may be, or is included in, a system-on-chip (SoC) along with one or more other components such as network connectivity components, sensors, video display components.

The software 410 can include an operating system and application programs such as a trip generation application 420 that may include components for communicating with trip generation service (e.g. running on server such as system 100 or system 500). Device operating systems generally control and coordinate the functions of the various components in the computing device, providing an easier way for applications to connect with lower level interfaces like the networking interface. Non-limiting examples of operating systems include Windows® from Microsoft Corp., Apple® iOS™ from Apple, Inc., Android® OS from Google, Inc., and the Ubuntu variety of the Linux OS from Canonical.

It should be noted that the operating system may be implemented both natively on the computing device and on software virtualization layers running atop the native device operating system (OS). Virtualized OS layers, while not depicted in FIG. 4, can be thought of as additional, nested groupings within the operating system space, each containing an OS, application programs, and APIs.

Storage system 415 may comprise any computer readable storage media readable by the processing system 405 and capable of storing software 410 including the trip generation application 420.

Storage system 415 may include volatile and nonvolatile, removable and non-removable media implemented in any method or technology for storage of information, such as computer readable instructions, data structures, program modules, or other data. Examples of storage media of storage system 415 include random access memory, read only memory, magnetic disks, optical disks, CDs, DVDs, flash memory, magnetic cassettes, magnetic tape, magnetic disk storage or other magnetic storage devices, or any other suitable storage media. In no case is the storage medium a propagated signal or carrier wave.

Storage system 415 may be implemented as a single storage device but may also be implemented across multiple storage devices or sub-systems co-located or distributed relative to each other. Storage system 415 may include additional elements, such as a controller, capable of communicating with processing system 405.

The system can further include user interface system 430, which may include input/output (I/O) devices and components that enable communication between a user and the system 400. User interface system 430 can include input devices such as a mouse, track pad, keyboard, a touch device for receiving a touch gesture from a user, a motion input device for detecting non-touch gestures and other motions by a user, a microphone for detecting speech, and other types of input devices and their associated processing elements capable of receiving user input.

The user interface system 430 may also include output devices such as display screen(s), speakers, haptic devices for tactile feedback, and other types of output devices. In certain cases, the input and output devices may be combined in a single device, such as a touchscreen display which both depicts images and receives touch gesture input from the user. A touchscreen (which may be associated with or form part of the display) is an input device configured to detect the presence and location of a touch. The touchscreen may be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or may utilize any other touchscreen technology. In some embodiments, the touchscreen is incorporated on top of a display as a transparent layer to enable a user to use one or more touches to interact with objects or other information presented on the display.

Visual output may be depicted on the display in myriad ways, presenting graphical user interface elements, text, images, video, notifications, virtual buttons, virtual keyboards, or any other type of information capable of being depicted in visual form.

The user interface system 430 may also include user interface software and associated software (e.g., for graphics chips and input devices) executed by the OS in support of the various user input and output devices. The associated software assists the OS in communicating user interface hardware events to application programs using defined mechanisms. The user interface system 430 including user interface software may support a graphical user interface, a natural user interface, or any other type of user interface. For example, the interfaces for the customization location-specific trip generation described herein may be presented through user interface system 430.

Communications interface 440 may include communications connections and devices that allow for communication with other computing systems over one or more communication networks (not shown). Examples of connections and devices that together allow for inter-system communication may include network interface cards, antennas, power amplifiers, RF circuitry, transceivers, and other communication circuitry. The connections and devices may communicate over communication media (such as metal, glass, air, or any other suitable communication media) to exchange communications with other computing systems or networks of systems. Transmissions to and from the communications interface are controlled by the OS, which informs applications of communications events when necessary.

FIG. 5 illustrates components of a computing system that may be used to implement certain methods and services described herein. Referring to FIG. 5, system 500 may be implemented within a single computing device or distributed across multiple computing devices or sub-systems that cooperate in executing program instructions. The system 500 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 500 can include a processing system 520, which may include one or more processors and/or other circuitry that retrieves and executes software 505 from storage system 515. Processing system 520 may be implemented within a single processing device but may also be distributed across multiple processing devices or sub-systems that cooperate in executing program instructions.

Examples of processing system 520 include general purpose central processing units, application specific processors, and logic devices, as well as any other type of processing device, combinations, or variations thereof. The one or more processing devices may include multiprocessors or multi-core processors and may operate according to one or more suitable instruction sets including, but not limited to, a Reduced Instruction Set Computing (RISC) instruction set, a Complex Instruction Set Computing (CISC) instruction set, or a combination thereof. In certain embodiments, one or more digital signal processors (DSPs) may be included as part of the computer hardware of the system in place of or in addition to a general purpose CPU.

Storage system(s) 515 can include any computer readable storage media readable by processing system 520 and capable of storing software 505 including instructions for customized location-specific trip generation service 510. Storage system 515 may include volatile and nonvolatile, removable and non-removable media implemented in any method or technology for storage of information, such as computer readable instructions, data structures, program modules, or other data. Examples of storage media include random access memory, read only memory, magnetic disks, optical disks, CDs, DVDs, flash memory, virtual memory and non-virtual memory, magnetic cassettes, magnetic tape, magnetic disk storage or other magnetic storage devices, or any other suitable storage media. In no case is the storage medium of storage system a propagated signal or carrier wave.

Storage system 515 may be implemented as a single storage device but may also be implemented across multiple storage devices or sub-systems co-located or distributed relative to each other. Storage system 515 may include additional elements, such as a controller, capable of communicating with processing system 520.

In some cases, storage system 515 includes a trips data resource 530. In other cases, the data resource 530 is part of a separate system with which system 500 communicates, such as a remote storage provider. For example, data, such as a plurality of trips, each trip having two or more individually specified destinations and associated metadata, may be stored on any number of remote storage platforms that may be accessed by the system 500 over communication networks via the communications interface 525. Such remote storage providers might include, for example, a server computer in a distributed computing network, such as the Internet. They may also include “cloud storage providers” whose data and functionality are accessible to applications through OS functions or APIs.

Software 505 may be implemented in program instructions and among other functions may, when executed by system 500 in general or processing system 520 in particular, direct the system 500 or processing system 520 to operate as described herein for a service 510 receiving communications associated with a customized location-specific trip generation application such as described herein.

Software 505 may also include additional processes, programs, or components, such as operating system software or other application software. It should be noted that the operating system may be implemented both natively on the computing device and on software virtualization layers running atop the native device operating system (OS). Virtualized OS layers, while not depicted in FIG. 5, can be thought of as additional, nested groupings within the operating system space, each containing an OS, application programs, and APIs.

Software 505 may also include firmware or some other form of machine-readable processing instructions executable by processing system 520.

System 500 may represent any computing system on which software 505 may be staged and from where software 505 may be distributed, transported, downloaded, or otherwise provided to yet another computing system for deployment and execution, or yet additional distribution.

In embodiments where the system 500 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 525 may be included, providing communication connections and devices that allow for communication between system 500 and other computing systems (not shown) over a communication network or collection of networks (not shown) or the air.

Certain techniques set forth herein with respect to customized location-specific trip generation may be described in the general context of computer-executable instructions, such as program modules, executed by one or more computing devices including holographic enabled devices. Generally, program modules include routines, programs, objects, components, and data structures that perform particular tasks or implement particular abstract data types.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

Embodiments may be implemented as a computer process, a computing system, or as an article of manufacture, such as a computer program product or computer-readable storage medium. Certain methods and processes described herein can be embodied as software, code and/or data, which may be stored on one or more storage media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

By way of example, and not limitation, computer-readable storage media may include volatile and non-volatile, removable and non-removable media implemented in any method or technology for storage of information such as computer-readable instructions, data structures, program modules or other data. Examples of computer-readable storage media include volatile memory such as random access memories (RAM, DRAM, SRAM); non-volatile memory such as flash memory, various read-only-memories (ROM, PROM, EPROM, EEPROM), phase change memory, magnetic and ferromagnetic/ferroelectric memories (MRAM, FeRAM), and magnetic and optical storage devices (hard drives, magnetic tape, CDs, DVDs). As used herein, in no case does the term “storage media” consist of carrier waves or propagating signals.

Certain aspects of the invention provide the following non-limiting examples.
Example 1. A method for customizing location-specific trips, comprising: managing, through a computing system, a trips data resource, the trips data resource comprising a plurality of trips, each trip having two or more individually specified destinations and associated metadata including at least a trip identifier, a destination identifier for each of the two or more individually specified destinations, geographical location for each of the two or more individually specified destinations, and keywords; obtaining geographical information and user information from user input of a request for customized location-specific trip generation; identifying, via the computing system, a set of relevant trips from at least the trips data resource, based on the geographical information and the user information; and providing the set of relevant trips to a source of the request.
Example 2. The method of example 1, wherein obtaining the geographical information comprises determining a geographical interest from the user input.
Example 3. The method of example 1 or 2, wherein obtaining the user information further comprises: receiving a user identification from the user input; and obtaining second user information based on the user identification from a user data resource, the second user information comprising stored user preferences and user history.
Example 4. The method of any of examples 1-3, wherein managing the trips data resource comprises receiving, via a submission portal, at least one trip and storing the at least one trip in the trips data resource.
Example 5. The method of any of examples 1-4, further comprising dynamically generating a second set of relevant trips from a destinations data resource, based on the geographical information and the user information, wherein the destinations data resource comprises a plurality of individual destinations.
Example 6. The method of example 5, wherein dynamically generating the second set of trips comprises: clustering sets of destinations from the plurality of individual destinations stored in the destinations data resource into area clusters of destinations based on a geographical location of each of the plurality of individual destinations; assigning a score to each of the area clusters based on the geographical information and the user information from the user input; and sorting each of the area clusters of destinations based on their assigned score to form a second set of relevant trips.
Example 7. The method of example 6, further comprising: merging the set of relevant trips that contain submitted trips and the second set of relevant trips that are formed of dynamically generated trips to form a merged set of relevant trips; identifying, from the merged set of relevant trips, a third set of relevant trips, based on the geographical information and the user information; and providing the third set of relevant trips as the set of relevant trips to the source of the request.
Example 8. The method of any of examples 1-7, wherein managing the trips data resource comprises receiving one or more dynamically generated trips of the second set of relevant trips and storing at least one of the one or more dynamically generated trips in the trips data resource.
Example 9. The method of any of examples 1-8, further comprising receiving an indication that a particular trip is selected from the set of relevant trips and storing information about the particular trip in an analytics data resource, the analytics data resource including search information and selection information.
Example 10. The method of example 9, further comprising: analyzing the search information and selection information to form insights about at least one destination of a trip, the insights including global popularities; generating an insight report, the insight report including the insights about the at least one destination; and providing the insight report to at least one entity associated with the at least one destination.
Example 11. A system for customizing location-specific trips, comprising: a processing system; a storage system; a trips data resource associated with the storage system; a data set stored on the trips database, the data set providing information on a plurality of trips, each trip having two or more individually specified destinations and associated metadata including at least a trip identifier, a destination identifier for each of the two or more individually specified destinations, geographical location for each of the two or more individually specified destinations, and keywords; and instructions for customizing location-specific trips stored on the storage system that when executed by the processing system, direct the processing system to at least: obtain geographical information and user information from user input of a request for customized location-specific trip generation; identify a set of relevant trips from at least the trips data resource, based on the geographical information and the user information; and provide the set of relevant trips to the source of the request.
Example 12. The system of example 11, wherein the instructions that direct the processing system to at least obtain the geographical information, direct the processing system to determine a geographical interest from the user input.
Example 13. The system of example 11 or 12, wherein the instructions that direct the processing system to at least obtain the user information, direct the processing system to obtain second user information from a user data resource based on a user identification obtained from the user input, the second user information comprising stored user preferences and user history.
Example 14. The system of any of examples 11-13, wherein the instructions that direct the processing system to at least manage the trips data resource, direct the processing system to: provide submission portal; and store a trip received via the submission portal in the trips data resource.
Example 15. The system of any of examples 11-14, wherein the instructions for customizing location-specific trips further direct the processing system to at least dynamically generate a second set of relevant trips from a destinations data resource, based on the geographical information and the user information, wherein the destinations data resource comprises a plurality of individual destinations.
Example 16. The system of example 15, wherein the instructions that direct the processing system to at least dynamically generate the second set of trips, direct the processing system to at least: cluster sets of destinations from the plurality of individual destinations stored in the destinations data resource into area clusters of destinations based on a geographical location of each of the plurality of individual destinations; assign a score to each of the area clusters based on the geographical information and the user information from the user input; and sort each of the area clusters of destinations based on their assigned score to form a second set of relevant trips.
Example 17. The system of example 16, wherein the instructions for customizing location-specific trips further direct the processing system to at least: merge the set of relevant trips and the second set of relevant trips to form a merged set of relevant trips; identify, from the merged set of relevant trips, a third set of relevant trips, based on the geographical information and the user information; and provide the third set of relevant trips as the set of relevant trips to the source of the request.
Example 18. The system of example 17, where the set of relevant trips are from the submitted trips and the second set of trips are from the dynamically generated trips.
Example 19. The system of any of examples 11-18, wherein the instructions for customizing location-specific trips further direct the processing system to at least: in response to receiving an indication that a particular trip is selected from the set of relevant trips, store information about the particular trip an analytics data resource, the analytics data resource including search information and selection information.
Example 20. The system of example 19, wherein the instructions for customizing location-specific trips further direct the processing system to at least: analyze the search information and selection information to form insights about at least one destination of a trip, the insights including global popularities; generate an insight report, the insight report including the insights about the at least one destination; and provide the insight report to at least one entity associated with the at least one destination.
Example 21. A system configured to perform any of the examples 1-10.
Example 22. One or more computer readable storage media having instructions stored thereon that when executed by a processing system direct the processing system to at least: provide submission portal; and store a trip received via the submission portal at a trips database; obtain geographical information and user information from user input of a request for customized location-specific trip generation; identify a set of relevant trips from at least the trips data resource, based on the geographical information and the user information; provide the set of relevant trips to the source of the request; dynamically generate a second set of relevant trips from a destinations data resource, based on the geographical information and the user information, wherein the destinations data resource comprises a plurality of individual destinations; and store at least one of the one or more dynamically generated trips in the trips data resource.
Example 23. One or more computer readable storage media having instructions stored thereon that when executed by a processing system direct the processing system to perform the method of any of examples 1-10.

It should be understood that the examples described herein are for illustrative purposes only and that various modifications or changes in light thereof will be suggested to persons skilled in the art and are to be included within the spirit and purview of this application.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims subject to any explicit definitions and disclaimers regarding terminology as provided above.

1. A method for customizing location-specific trips, comprising:
managing, through a computing system, a trips data resource, the trips data resource comprising a plurality of trips, each trip having two or more individually specified destinations and associated metadata including at least a trip identifier, a destination identifier for each of the two or more individually specified destinations, geographical location for each of the two or more individually specified destinations, and keywords;
obtaining geographical information and user information from user input of a request for customized location-specific trip generation;
identifying, via the computing system, a set of relevant trips from at least the trips data resource, based on the geographical information and the user information; and
providing the set of relevant trips to a source of the request.

2. The method of claim 1, wherein obtaining the geographical information comprises determining a geographical interest from the user input.

3. The method of claim 1, wherein obtaining the user information further comprises:
receiving a user identification from the user input; and
obtaining second user information based on the user identification from a user data resource, the second user information comprising stored user preferences and user history.

4. The method of claim 1, wherein managing the trips data resource comprises receiving, via a submission portal, at least one trip and storing the at least one trip in the trips data resource.

5. The method of claim 1, further comprising dynamically generating a second set of relevant trips from a destinations data resource, based on the geographical information and the user information, wherein the destinations data resource comprises a plurality of individual destinations.

6. The method of claim 5, wherein dynamically generating the second set of trips comprises:
clustering sets of destinations from the plurality of individual destinations stored in the destinations data resource into area clusters of destinations based on a geographical location of each of the plurality of individual destinations;
assigning a score to each of the area clusters based on the geographical information and the user information from the user input; and
sorting each of the area clusters of destinations based on their assigned score to form a second set of relevant trips.

7. The method of claim 6, further comprising:
merging the set of relevant trips and the second set of relevant trips to form a merged set of relevant trips;
identifying, from the merged set of relevant trips, a third set of relevant trips, based on the geographical information and the user information; and
providing the third set of relevant trips as the set of relevant trips to the source of the request.

8. The method of claim 5, wherein managing the trips data resource comprises receiving one or more dynamically generated trips of the second set of relevant trips and storing at least one of the one or more dynamically generated trips in the trips data resource.

9. The method of claim 1, further comprising receiving an indication that a particular trip is selected from the set of relevant trips and storing information about the particular trip in an analytics data resource, the analytics data resource including search information and selection information.

10. The method of claim 9, further comprising:
analyzing the search information and selection information to form insights about at least one destination of a trip, the insights including global popularities;
generating an insight report, the insight report including the insights about the at least one destination; and
providing the insight report to at least one entity associated with the at least one destination.

11. A system for customizing location-specific trips, comprising:
a processing system;
a storage system;
a trips data resource associated with the storage system;
a data set stored on the trips data resource, the data set providing information on a plurality of trips, each trip having two or more individually specified destinations and associated metadata including at least a trip identifier, a destination identifier for each of the two or more individually specified destinations, geographical location for each of the two or more individually specified destinations, and keywords; and
instructions for customizing location-specific trips stored on the storage system that when executed by the processing system, direct the processing system to at least:
obtain geographical information and user information from user input of a request for customized location-specific trip generation;
identify a set of relevant trips from at least the trips data resource, based on the geographical information and the user information; and
provide the set of relevant trips to the source of the request.

12. The system of claim 11, wherein the instructions that direct the processing system to at least obtain the geographical information, direct the processing system to determine a geographical interest from the user input.

13. The system of claim 11, wherein the instructions that direct the processing system to at least obtain the user information, direct the processing system to obtain second user information from a user data resource based on a user identification obtained from the user input, the second user information comprising stored user preferences and user history.

14. The system of claim 11, wherein the instructions that direct the processing system to at least manage the trips data resource, direct the processing system to:
provide submission portal; and
store a trip received via the submission portal in the trips data resource.

15. The system of claim 11, wherein the instructions for customizing location-specific trips further direct the processing system to at least dynamically generate a second set of relevant trips from a destinations data resource, based on the geographical information and the user information, wherein the destinations data resource comprises a plurality of individual destinations.

16. The system of claim 15, wherein the instructions that direct the processing system to at least dynamically generate the second set of trips, direct the processing system to at least:
cluster sets of destinations from the plurality of individual destinations stored in the destinations data resource into area clusters of destinations based on a geographical location of each of the plurality of individual destinations;
assign a score to each of the area clusters based on the geographical information and the user information from the user input; and
sort each of the area clusters of destinations based on their assigned score to form a second set of relevant trips.

17. The system of claim 16, wherein the instructions for customizing location-specific trips further direct the processing system to at least:
merge the set of relevant trips and the second set of relevant trips to form a merged set of relevant trips;
identify, from the merged set of relevant trips, a third set of relevant trips, based on the geographical information and the user information; and
provide the third set of relevant trips as the set of relevant trips to the source of the request.

18. The system of claim 11, wherein the instructions for customizing location-specific trips further direct the processing system to at least: in response to receiving an indication that a particular trip is selected from the set of relevant trips, store information about the particular trip an analytics data resource, the analytics data resource including search information and selection information.

19. The system of claim 18, wherein the instructions for customizing location-specific trips further direct the processing system to at least:
analyze the search information and selection information to form insights about at least one destination of a trip, the insights including global popularities;
generate an insight report, the insight report including the insights about the at least one destination; and
provide the insight report to at least one entity associated with the at least one destination.

20. One or more computer readable storage media having instructions stored thereon that when executed by a processing system direct the processing system to at least:
provide submission portal; and
store a trip received via the submission portal at a trips data resource;
obtain geographical information and user information from user input of a request for customized location-specific trip generation;
identify a set of relevant trips from at least the trips data resource, based on the geographical information and the user information;
provide the set of relevant trips to the source of the request;
dynamically generate a second set of relevant trips from a destinations data resource, based on the geographical information and the user information, wherein the destinations data resource comprises a plurality of individual destinations; and
store at least one of the one or more dynamically generated trips in the trips data resource.
